(19) United States
(12) Patent Application Publication
(10) Pub. No.: US 2013/0308836 A1
(43) Pub. Date: Nov. 21, 2013

(54) PHOTO IMAGE MANAGING METHOD AND PHOTO IMAGE MANAGING SYSTEM

(71) Applicant: TZU-HUNG CHENG, Taipei (TW)

(72) Inventor: TZU-HUNG CHENG, Taipei (TW)

(73) Assignee: PRIMAX ELECTRONICS LTD., Taipei (TW)

(21) Appl. No.: 13/567,300

(22) Filed: Aug. 6, 2012

(30) Foreign Application Priority Data
May 18, 2012 (TW) 101117758

(51) Int. Cl. G06K 9/62

(52) U.S. Cl. 382/118

(57) ABSTRACT

A photo image managing method includes the following steps. Firstly, a face recognizing operation is performed to acquire at least one target face image contained in a photo image. Then, the target face image is compared with plural face images stored in a face database, and thus plural resembling face images are acquired. Then, the user may judge which resembling face image is identical to the target face image, and thus selects a specified resembling face image. The specified resembling face image is correlated with a face name. Afterwards, the face name corresponding to the specified resembling face image is assigned to the target face image, so that the relationship between the assigned face name and the target photo image is established.

### FIELD OF THE INVENTION

The present invention relates to a photo image managing method, and more particularly to a photo image managing method for classifying photo images according to the content of each photo image.

### BACKGROUND OF THE INVENTION

Image pickup devices are usually employed to take photos. Conventionally, the image pickup devices are film cameras that use films. With the advent of the digitalized generation, the image pickup devices are gradually developed as digital cameras or video cameras without the need of using films. In addition to the function of taking photos, the digitalized image pickup devices also have the photographic function of recording dynamic movies. The photos or movies acquired by an image pickup device may be stored in an electronic device (e.g. a computer) in the form of electronic files. The photo images and the movie images may be watched by the user through the electronic device, and the favorite images may be selected and outputted as the conventional photos.

With increasing development of science and technology, image pickup devices have become essential components of electronic devices (e.g. mobile phones, notebook computers and tablet personal computers). Among theses electronic devices, smart phones and tablet personal computers are more advantageous because of their easy portability. Consequently, almost all of the smart phones and the tablet personal computers are equipped with image pickup devices for facilitating the users to obtain photos or movies.

Moreover, since the image pickup devices are digitalized, it is important to manage the electronic files of the photo images and the movie images. Generally, the photo images or the movie images captured by an image pickup device are transmitted to a computer host. Under execution of an operating system in the computer host, a photo folder may be created to contain the photo images or the movie images.

Please refer to FIGS. 1 and 2. FIG. 1 schematically illustrates a window showing plural photo images of a photo folder according to the prior art. FIG. 2 schematically illustrates a representative thumbnail of the photo folder of FIG. 1. As shown in FIG. 1, the window 1 is a user operation interface. Through the window 1, plural photo images 101 contained in a photo folder 10 may be viewed by the user. As known, although these photo images 101 are shown on the window 1, these photo images 101 are not stored in the window 1. Whereas, these photo images 101 are stored in a computer system (not shown).

In FIG. 2, the photo folder 10 is shown, and the photo folder 10 is displayed on the window 1. By clicking the photo folder 10 that is displayed on the window 1, the photo folder 10 is opened, and thus the photo images 101 contained in the photo folder 10 are viewable (see FIG. 1). After the browsing page is backward to the previous page, the photo folder 10 is displayed on the window 1 again. Moreover, some photo images 101 of the photo folder 10 are displayed on the window 1 of the photo folder 10 in the forms of thumbnails. That is, plural representative thumbnails P of the photo folder 10 are shown. By viewing the representative thumbnails P of the photo images 101, the user can recognize the face images or the landscape images contained in the photo images 101.

As known, the photo folder usually contains a large number of photo images. If the user wants to select desired photo images, the user may open the photo folder and sequentially view the photo images. In addition, the searching function of the photo folder may be utilized to search the filenames of the desired photo images. That is, for facilitating the user to implement the searching function in the future, the user has to edit the filenames of all photo images. In the photo folder 10 as shown in FIG. 1, the first photo image 101 is a photo image of a first user U1. Generally, the user may input “U1” as the filename of the first photo image 101. From now on, the user may utilize the searching function of the photo folder and type the word “U1” in a filename box to search this photo image. Alternatively, all photo images may be sequentially and manually classified according to the contents thereof, and the photo images are moved to different folders according to the classifications. However, since most users have a large number of photo images, the conventional method of managing the photo images has some drawbacks. For example, it is time-consuming and labor-intensive to sequentially edit the filenames of all photo images or moving the photo images to different folders. Furthermore, during the process of modifying the photo images or moving the photo images, the photo images are readily damaged or lost.

Therefore, there is a need of providing a time-saving photo image managing method and a photo image managing system thereof.

### SUMMARY OF THE INVENTION

The present invention provides a time-saving photo image managing method and a photo image managing system thereof.

In accordance with an aspect of the present invention, there is provided a photo image managing method. The photo image managing method includes the following steps. Firstly, a face database including plural face images is provided, wherein each face image is correlated with a face name. Then, a face recognizing operation is performed on a target photo image, thereby acquiring at least one target face image. Then, plural resembling face images similar to the at least one target face image are sequentially searched from the plural face images of the face database. Then, the at least one target face image, the plural resembling face images and plural face names corresponding to the plural resembling face images are shown. After a specified resembling face image is selected from the plural resembling face images, the face name corresponding to the specified resembling face image is assigned to the target face image. As a consequence, a relationship between the assigned face name and the target photo image is established.

In an embodiment, if a first target face image and a second target face image are acquired after the face recognizing operation is performed on the target photo image, the photo image managing method further includes steps of searching the plural resembling face images similar to the first target face image from the face database, and searching plural additional resembling face images similar to the second target face image from the face database.

In an embodiment, if a first face name corresponding to the specified resembling face image is assigned to the first target face image and a relationship between the first face name and the target photo image is established, the photo image managing method further includes steps of showing the second target face image, the plural additional resembling face images and plural face names corresponding to the plural additional resembling face images, selecting a specified additional resembling face image from the plural additional resembling face images, and assigning a second face name corresponding to the specified additional resembling face image to the second target face image, thereby established a relationship between the second face name and the target photo image is established.

In an embodiment, after the relationship between the first face name and the target photo image is established, the photo image managing method further includes a step of providing a displaying control interface for determining whether the second target face image will be displayed or a next target photo image will be recognized.

In an embodiment, the at least one target face image, the plural resembling face images and the plural face names corresponding to the plural resembling face images are shown on a selecting interface. Moreover, the step of selecting the specified resembling face image from the plural resembling face images is performed by using a finger or a stylus to touch the specified resembling face image shown on the selecting interface, wherein the photo image managing method is executed by an electronic device with a touch control function.

In an embodiment, the at least one target face image, the plural resembling face images and the plural face names corresponding to the plural resembling face images are shown on a selecting interface. Moreover, the step of selecting the specified resembling face image from the plural resembling face images is performed by moving a cursor to click the specified resembling face image shown on the selecting interface, wherein the photo image managing method is executed by a desktop computer or a notebook computer.

In accordance with another aspect of the present invention, there is provided a photo image managing system. The photo image managing system is installed in a computer system with a storage unit and a controlling unit. The storage unit stores a target photo image, a face database and plural face images. The controlling unit is in communication with the storage unit. The photo image managing system includes a face recognizing module, a comparing module, a selecting module, and an assigning module. The face recognizing module is in communication with the controlling unit for issuing a recognizing signal to the controlling unit. In response to the recognizing signal, the controlling unit performs a face recognizing operation on the target photo image, thereby acquiring at least one target face image. The comparing module is in communication with the controlling unit for issuing a comparing signal to the controlling unit. In response to the comparing signal, the controlling unit sequentially searches plural resembling face images similar to the at least one target face image from the face database. The selecting module is in communication with the controlling unit for providing a selecting interface, so that a specified resembling face image is acquired via the selecting interface. The assigning module is in communication with the controlling unit for issuing an assigning signal to the controlling unit. In response to the assigning signal, the controlling unit assigns the face name corresponding to the specified resembling face image to the at least one target face image, thereby establishing a relationship between the assigned face name and the target photo image.

In an embodiment, the computer system further includes a display screen for displaying the selecting interface, the at least one target face image, the plural resembling face images and the plural face names corresponding to the plural resembling face images.

In an embodiment, the selecting module further provides a displaying control interface, wherein the displaying control interface is displayed on the display screen for determining whether a next target face image will be displayed or a next target photo image will be recognized.

In an embodiment, the specified resembling face image is selected by using a finger or a stylus to touch the specified resembling face image shown on the selecting interface, wherein the computer system is an electronic device with a touch control function.

In an embodiment, the specified resembling face image is selected by moving a cursor to click the specified resembling face image shown on the selecting interface, wherein the computer system is a desktop computer or a notebook computer.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a window showing plural photo images of a photo folder according to the prior art;

FIG. 2 schematically illustrates a representative thumbnail of the photo folder of FIG. 1;

FIG. 3 is a block flow diagram illustrating a photo image managing method according to an embodiment of the present invention;

FIG. 4 is a schematic block diagram illustrating a photo image managing system according to an embodiment of the present invention;

FIGS. 5A˜5C schematically illustrate the face images and corresponding face names contained in the face database of the photo image managing system according to an embodiment of the present invention;

FIG. 6 schematically illustrates a target photo image shown on a window of the photo image managing system according to an embodiment of the present invention;

FIG. 7 schematically illustrates a selecting interface of the photo image managing system according to an embodiment of the present invention; and

FIG. 8 schematically illustrates a displaying control interface of the photo image managing system according to an embodiment of the present invention.

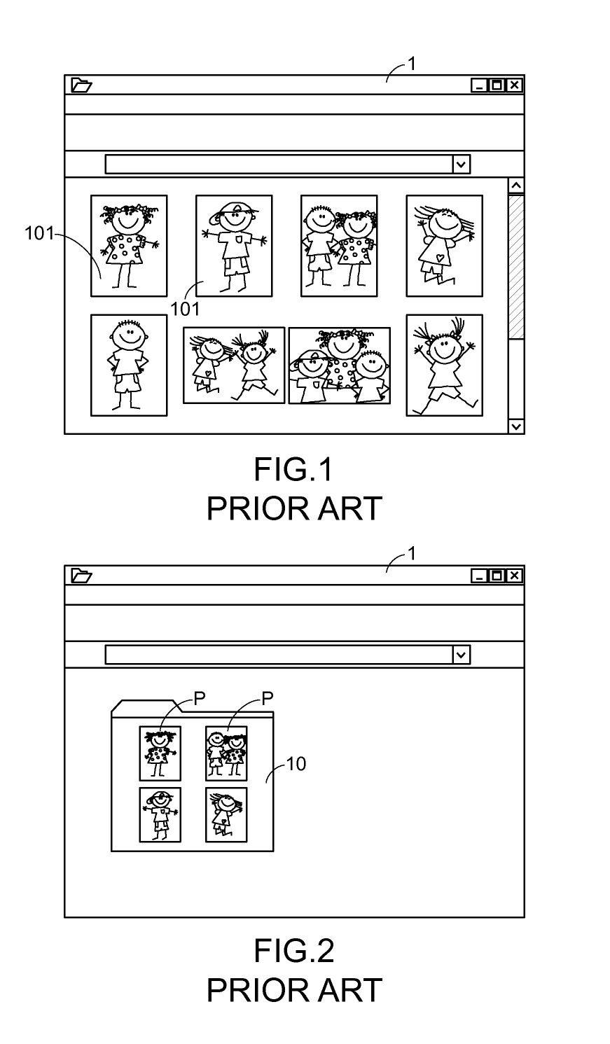

### DETAILED DESCRIPTION OF THE PREFERRED EMBODIMENT

For eliminating the drawbacks encountered from the prior art, the present invention provides a photo image managing method and a photo image managing system.

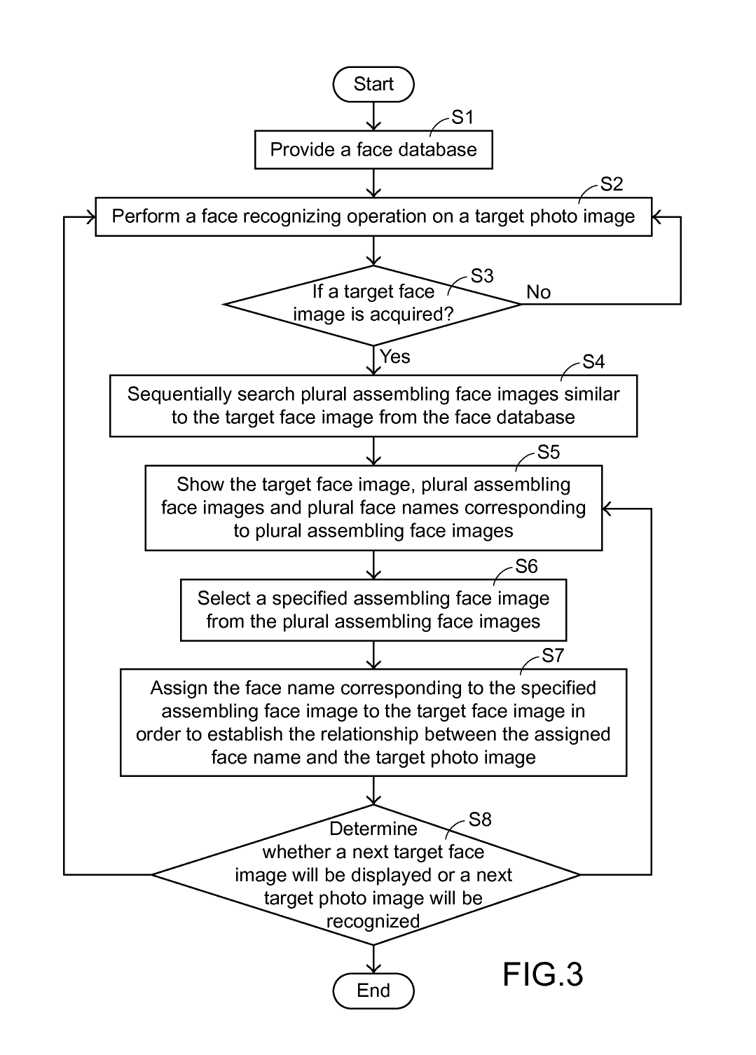

FIG. 3 is a block flow diagram illustrating a photo image managing method according to an embodiment of the present invention. The photo image managing method comprises the following steps. Firstly, in the step S1, a face database is provided. Then, in the step S2, a face recognizing operation is performed on a target photo image. Then, the step S3 is done to judge whether a target face image is acquired. Then, in the step S4, the resembling face images that are similar to the target face image are searched from the face database. Then, in the step S5, the target face image, plural resembling face images and plural face names corresponding to plural resembling face images are shown. Then, in the step S6, a specified resembling face image is selected from the plural resembling face images. Then, in the step S7, the face name corresponding to the specified resembling face image is assigned to the target face image, and thus the relationship between the assigned face name and the target photo image is established. Afterwards, the step S8 is performed to determine whether a next target face image will be displayed or a next target photo image will be recognized.

In the photo image managing method, if a target face image is acquired in the step S3, the step S4 is performed. Whereas, if the judging result of the step S3 shows that no target face image is acquired by the face recognizing operation of the step S2, the step S2 will be done again in order to recognize a next target photo image. Moreover, if the user decides to display a next target face image in the step S8, the step S5 will be done again in order to display the next target face image. Whereas, if the user decides to recognize a next target photo image in the step S8, the step S2 will be done again in order to recognize the next target photo image. Whereas, if the user decides to terminate the process flow, the photo image managing method is ended.

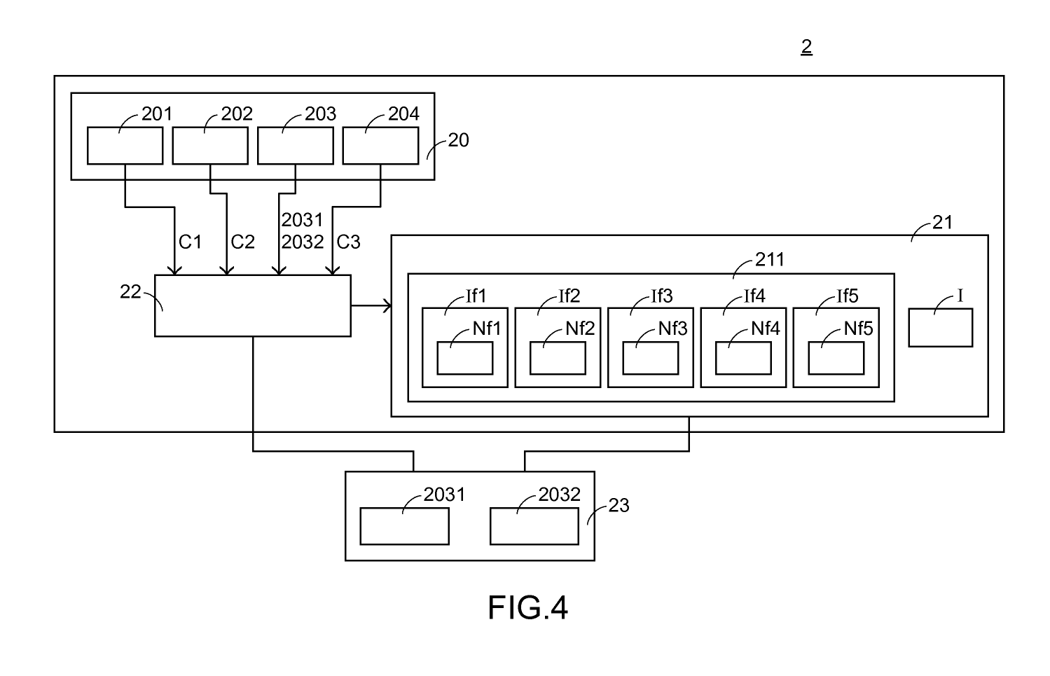

Hereinafter, the basic architecture of a photo image managing system of the present invention will be illustrated with reference to FIG. 4. FIG. 4 is a schematic block diagram illustrating a photo image managing system according to an embodiment of the present invention. As shown in FIG. 4, the photo image managing system 20 is installed in a computer system 2. The computer system 2 comprises a storage unit 21, a controlling unit 22, and a display screen 23. The storage unit 21 is used for storing at least one target photo image I, a face database 211, and plural face images If1, If2, . . . , If5. The controlling unit 22 is in communication with the storage unit 21. The display screen 23 is in communication with the storage unit 21 and the controlling unit 22. Moreover, the photo image managing system 20 comprises a face recognizing module 201, a comparing module 202, a selecting module 203, and an assigning module 204. The face recognizing module 201, the comparing module 202, the selecting module 203 and the assigning module 204 are in communication with the controlling unit 22 for issuing different signals to the controlling unit 22. In response to these signals, the controlling unit 22 performs corresponding actions. In this embodiment, the computer system 2 is an electronic device with a touch control function. For example, the computer system 2 is a touch smart phone or a tablet personal computer. Under this circumstance, the photo image managing system 20 is an application program installed in the computer system 2, the storage unit 21 is a hard disc, and the controlling unit 22 is a central processing unit. In some embodiments, the computer system is a desktop computer or a notebook computer.

The operations of the photo image managing system 20 will be illustrated in more details as follows. Please refer to FIG. 4 again. Firstly, the photo image managing system 20 is enabled to provide the face database 211 (see the step S1 as shown in FIG. 3). For example, the photo image managing system 20 may be enabled by clicking a shortcut icon shown on a user operation interface (not shown). The user operation interface and the shortcut icon thereon are well known in the art, and are not redundantly described herein. The face database 211 comprises plural face images If1, If2, . . . , If5 and plural face names Nf1, Nf2, . . . , Nf5. The face image If1 is correlated with the face name Nf1. The face image If2 is correlated with the face name Nf2. That is, the face name shown on the face image If1 is the face name Nf1.

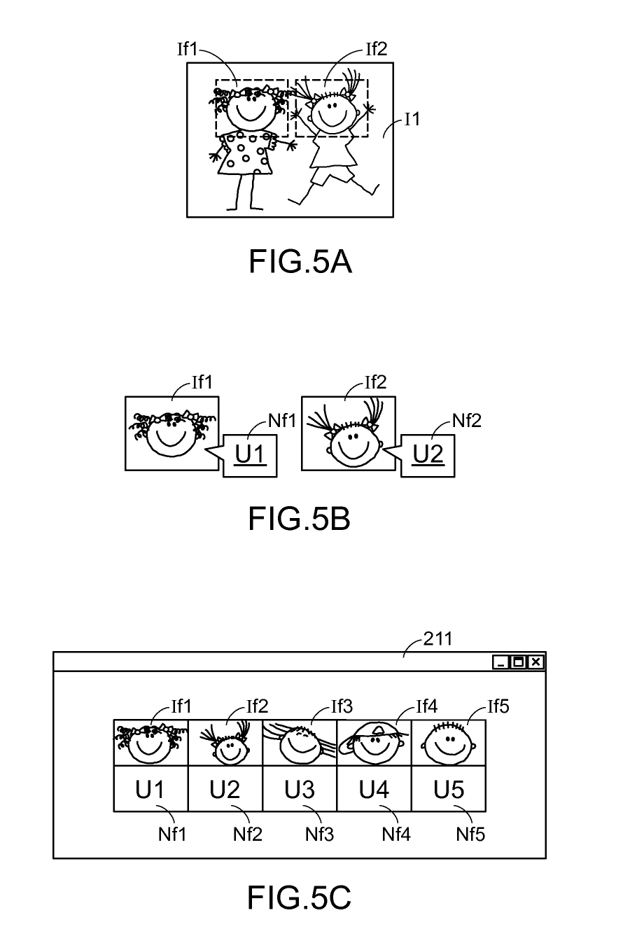

Hereinafter, a process of creating the face database 211 will be illustrated with reference to FIGS. 5A˜5C. FIGS. 5A˜5C schematically illustrate the face images and corresponding face names contained in the face database of the photo image managing system according to an embodiment of the present invention. In FIG. 5A, a photo image 11 is shown. The photo image 11 contains a first face image If1 and a second face image If2. When the user wants to create the face database 211, the following steps will be sequentially done. Firstly, the user may operate the face recognizing module 201 to issue a recognizing signal C1 to the controlling unit 22. In response to the recognizing signal C1, the controlling unit 22 performs a face recognizing operation on the photo image 11, thereby acquiring the first face image If1 and the second face image If2 from the photo image 11. Then, the user may input the first face name Nf1 into the image data of the first face image If1. The content of the first face name Nf1 is the name “U1” of the first user U1 corresponding to the first face image If1. Similarly, the second face name Nf2 of the second user U2 is inputted into to the image data of the second face image If2 (see FIG. 5B). Afterwards, the first face name Nf1, the corresponding first face image If1, the second face name Nf2 and the corresponding second face image If2 are stored in the face database 211.

Furthermore, during the process of creating the face database 211, the controlling unit 22 also performs face recognizing operations on the other photo images. Consequently, the third face image If3, the fourth face image If4 and the fifth face image If5 are acquired. The third face image If3 is correlated with the third face name Nf3, the fourth face image If4 is correlated with the fourth face name Nf4, and the fifth face image If5 is correlated with the fifth face name Nf5. The content of the third face name Nf3 is the name “U3” of the third user U3 corresponding to the third face image If3. The content of the fourth face name Nf4 is the name “U4” of the fourth user U4 corresponding to the fourth face image If4. The content of the fifth face name Nf5 is the name “U5” of the fifth user U5 corresponding to the fifth face image If5 (see FIG. 5C). Similarly, the third face name Nf3, the corresponding third face image If3, the fourth face name Nf4, the corresponding fourth face image If4, the fifth face name Nf5 and the corresponding fifth face image If5 are also stored in the face database 211. Moreover, the face database 211 is stored in the storage unit 21.

In this embodiment, the face recognizing operation is implemented to acquire the first face image If1 and the second face image If2 by the face recognizing module 201 and the controlling unit 22. Alternatively, in the some other embodiments, the face images may be recognized by naked eyes of the user. Furthermore, the user may directly circumscribe the face image from the photo image, and then input the face name corresponding to the circumscribed face image.

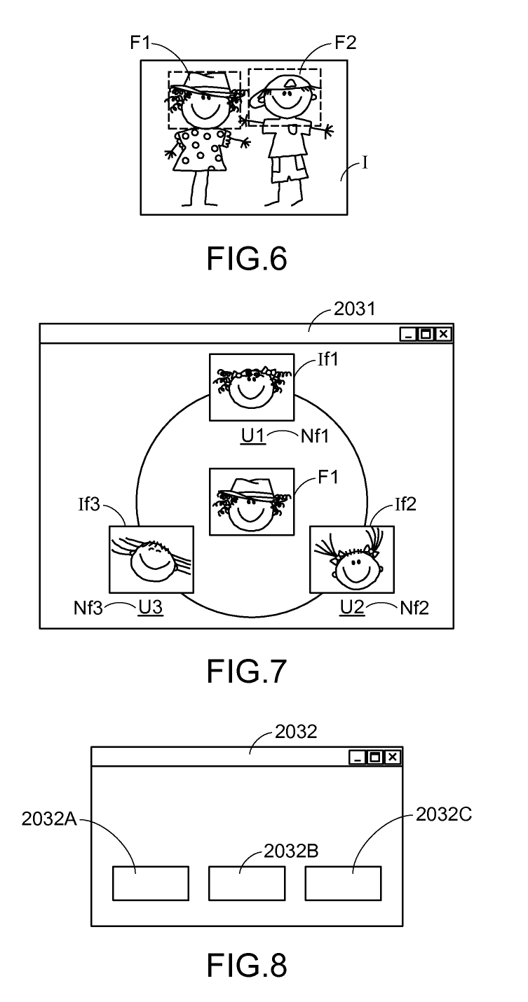

FIG. 6 schematically illustrates a target photo image shown on a window of the photo image managing system according to an embodiment of the present invention. After the face database 211 is created, one of the plural photo images stored in the storage unit 21 of the computer system may be selected to be managed. The selected photo image is defined as a target photo image I. Then, the face recognizing module 201 to issue a recognizing signal C1 to the controlling unit 22. In response to the recognizing signal C1, the controlling unit 22 performs a face recognizing operation on the target photo image I (see the step S2 as shown in FIG. 3). After the face recognizing operation is performed by the controlling unit 22, the controlling unit 22 judges whether at least one face image is acquired from the target photo image I (see the step S3 as shown in FIG. 3). If no face image is acquired by the face recognizing operation, it means that the target photo image I is a landscape image without any face image. Consequently, the step S2 is repeatedly done to perform a face recognizing operation on a next photo image. Whereas, if a face image is acquired by the face recognizing operation, the step S4 is performed. This face image is defined as a target face image. In this embodiment, after the controlling unit 22 performs the face recognizing operation on the target photo image I, two target face images are acquired. The two target face image includes a first target face image F1 and a second target face image F2.

After the controlling unit 22 performs the face recognizing operation on the target photo image I to acquire the first target face image F1 and the second target face image F2, a comparing operation is performed on the first target face image F1. The comparing module 202 issues a comparing signal C2 to the controlling unit 22. In response to the comparing signal C2, the controlling unit 22 sequentially searches face images similar to the first target face image F1 from the face database 211 (see the step S4 as shown in FIG. 3). The face images similar to the first target face image F1 are defined as resembling face images. For example, in response to the comparing signal C2, the controlling unit 22 sequentially compares the facial features of the first target face image F1 with the facial features of the face images If1˜If5 in the face database 211. In addition, the face images whose facial features are similar to the facial features of the first target face image F1 and the corresponding face names are selected. In this embodiment, the controlling unit 22 judges that the resembling face images that are similar to the first target face image F1 includes the first face image If1, the second face image If2 and the third face image If3.

FIG. 7 schematically illustrates a selecting interface of the photo image managing system according to an embodiment of the present invention. Please refer to FIGS. 4 and 7. As shown in FIG. 4, a selecting interface 2031 is provided by the selecting module 203. Moreover, the selecting interface 2031 is displayed on the display screen 23. For allowing selection by the user, the first target face image F1, plural resembling face images and plural face names corresponding to the plural resembling face images are shown on the selecting interface 2031, which is displayed on the display screen 23 (see the step S5 as shown in FIG. 3). As shown in FIG. 7, the first target face image F1 is located at a middle region of the selecting interface 2031. The first face image If1, the second face image If2 and the third face image If3 that are similar to the first target face image F1 are arranged around the first target face image F1. The first face name Nf1, the second face name Nf2 and the third face name Nf3 are respectively located under the corresponding face images.

Then, the user judges that the first face image If1 of the plural face images matches the first target face image F1 and both of the first face image If1 and the first target face image F1 are the face images of the first user U1. By using the finger to touch the first face image If1 shown on the selecting interface 2031, the first face image If1 is selected (see the step S6 as shown in FIG. 3). It means that the face of the first face image If1 is identical to the face of the first target face image F1. Of course, the user may use a touch element (e.g. a stylus) to touch and select face image shown on the selecting interface 2031 of the display screen 23. When the first face image If1 is selected by the user, the assigning module 204 issues an assigning signal C3 to the controlling unit 22. In response to the assigning signal C3, the face name corresponding to the selected first face image If1 (i.e. the first face name Nf1) is assigned to the first target face image F1 by the controlling unit 22. Consequently, the relationship between the first face name Nf1 and the target photo image I is established (see the step S7 as shown in FIG. 3). That is, the first face name Nf1 corresponding to the first user U1 is inputted into the image data of the first target face image F1 of the target photo image I.

FIG. 8 schematically illustrates a displaying control interface of the photo image managing system according to an embodiment of the present invention. After the relationship between the first face name Nf1 and the target photo image I is established, a displaying control interface 2032 is created by the selecting module 203. The displaying control interface 2032 is also displayed on the display screen 23. The displaying control interface 2032 is used for allowing the user to determine whether a next target face image will be displayed or a next target photo image will be recognized (see the step S8 as shown in FIG. 3). As shown in FIG. 8, the displaying control interface 2032 comprises a displaying selective item 2032A, a recognizing selective item 2032B, and an ending selective item 2032C. By clicking the displaying selective item 2032A, a next target face image (i.e. the second target face image F2) of the target photo image I will be displayed. By clicking the recognizing selective item 2032B, a next target photo image will be recognized. By clicking the ending selective item 2032C, the photo image managing system 20 is disabled.

If the displaying selective item 2032A of the displaying control interface 2032 is touched by the user, it means that the second target face image F2 of the target photo image I is selected to be displayed by the user. Consequently, the second target face image F2, plural resembling face images and plural face names corresponding to the plural resembling face images are shown on the selecting interface 2031 (see the step S5 as shown in FIG. 3). The subsequent processing operations performed on the second target face image F2 by the photo image managing system 20 are similar to the subsequent processing operations performed on the first target face image F1, and are not redundantly described herein. On the other hand, if the recognizing selective item 2032B of the displaying control interface 2032 is touched by the user, it means that no any other target face image is contained in the target photo image I. Meanwhile, a face recognizing operation is performed on the next target photo image (see the step S2 as shown in FIG. 3). On the other hand, if the ending selective item 2032C of the displaying control interface 2032 is touched by the user, it means that no any other target photo image needs to be recognized. Consequently, the photo image managing system 20 is disabled, and the photo image managing method is completed.

After the photo image managing method is completed, since the relationships between the face images of the photo images and the corresponding face names are established, the user may utilize the searching function of the folder to search a desired face name (e.g. “U5”). After the face name “U5” is inputted into the search box, the photo images containing the face image corresponding to the face name “U5” are searched from the folder. In other words, the desired photo images can be searched without the need of inputting the filenames of the photo images.

From the above discussions, the photo image managing method of the present invention is effective to manage photo images according to the face images. During the process of selecting the photo images to be managed, if the user negligently chooses a photo image without any face image and the controlling unit 22 fails to acquire the target photo image through recognition, the controlling unit 22 fails to perform the subsequent steps. Under this circumstance, the photo image managing method may be erroneously stopped. However, since the photo image managing method further comprises the step S3, even if a photo image without any face image is chosen, the problem of erroneously stopping the photo image managing method will be eliminated.

In a preferred embodiment of the photo image managing method of the present invention, after all face images contained in the photo image are recognized, the first target face image and the plural resembling face images similar to first target face image are shown on the selecting interface, and then the second target face image and the plural resembling face images similar to the second target face image are shown. In some other embodiments of the photo image managing method of the present invention, after all face images contained in the photo image are recognized, the first target face image, the plural resembling face images similar to the first target face image, the second target face image and the plural resembling face images similar to the second target face image are simultaneously shown. It is noted that the sequence of showing these face images may be set according to the user's preference.

Moreover, the photo image managing method of the present invention may be applied to an electronic device with a touch control function. Also, the photo image managing method of the present invention may be applied to a desktop computer or a notebook computer. The selecting interface and the displaying control interface may be operated by a cursor click effect.

From the above description, the present invention provides a photo image managing method and a photo image managing system. After the target face image contained in the photo image is recognized, the recognized target face image is compared with the face images stored in the face database. Consequently, plural resembling face images are acquired. Then, the user may judge whether the face of any resembling face image is identical to the face of the target face image, and thus selects a specified resembling face image whose face is identical to the face of the target face image. Afterwards, the face name corresponding to the specified resembling face image is assigned to the target face image, so that the relationship between the assigned face name and the target photo image is established. In such way, the user can search the target face image without the need of personally viewing the face images contained in all photo images. That is, the process of searching the target face image is time-saving and labor-saving.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A photo image managing method, comprising steps of:
providing a face database including plural face images, wherein each face image is correlated with a face name;
performing a face recognizing operation on a target photo image, thereby acquiring at least one target face image;
sequentially searching plural resembling face images similar to said at least one target face image from said plural face images of said face database;
showing said at least one target face image, said plural resembling face images and plural face names corresponding to said plural resembling face images; and
selecting a specified resembling face image from said plural resembling face images; and
assigning said face name corresponding to said specified resembling face image to said target face image, thereby establishing a relationship between said assigned face name and said target photo image.

2. The photo image managing method according to claim 1, wherein if a first target face image and a second target face image are acquired after said face recognizing operation is performed on said target photo image, said photo image managing method further comprises steps of searching said plural resembling face images similar to said first target face image from said face database, and searching plural additional resembling face images similar to said second target face image from said face database.

3. The photo image managing method according to claim 2, wherein if a first face name corresponding to said specified resembling face image is assigned to said first target face image and a relationship between said first face name and said target photo image is established, said photo image managing method further comprises steps of showing said second target face image, said plural additional resembling face images and plural face names corresponding to said plural additional resembling face images, selecting a specified additional resembling face image from said plural additional resembling face images, and assigning a second face name corresponding to said specified additional resembling face image to said second target face image, thereby established a relationship between said second face name and said target photo image is established.

4. The photo image managing method according to claim 3, wherein after said relationship between said first face name and said target photo image is established, said photo image managing method further comprises a step of providing a displaying control interface for determining whether said second target face image will be displayed or a next target photo image will be recognized.

5. The photo image managing method according to claim 1, wherein said at least one target face image, said plural resembling face images and said plural face names corresponding to said plural resembling face images are shown on a selecting interface, wherein said step of selecting said specified resembling face image from said plural resembling face images is performed by using a finger or a stylus to touch said specified resembling face image shown on said selecting interface, wherein said photo image managing method is executed by an electronic device with a touch control function.

6. The photo image managing method according to claim 1, wherein said at least one target face image, said plural resembling face images and said plural face names corresponding to said plural resembling face images are shown on a selecting interface, wherein said step of selecting said specified resembling face image from said plural resembling face images is performed by moving a cursor to click said specified resembling face image shown on said selecting interface, wherein said photo image managing method is executed by a desktop computer or a notebook computer.

7. A photo image managing system installed in a computer system with a storage unit and a controlling unit, said storage unit storing a target photo image, a face database and plural face images, said controlling unit being in communication with said storage unit, said photo image managing system comprising:
a face recognizing module in communication with said controlling unit for issuing a recognizing signal to said controlling unit, wherein in response to said recognizing signal, said controlling unit performs a face recognizing operation on said target photo image, thereby acquiring at least one target face image;
a comparing module in communication with said controlling unit for issuing a comparing signal to said controlling unit, wherein in response to said comparing signal, said controlling unit sequentially searches plural resembling face images similar to said at least one target face image from said face database;
a selecting module in communication with said controlling unit for providing a selecting interface, so that a specified resembling face image is acquired via said selecting interface; and
an assigning module in communication with said controlling unit for issuing an assigning signal to said controlling unit, wherein in response to said assigning signal, said controlling unit assigns said face name corresponding to said specified resembling face image to said at least one target face image, thereby establishing a relationship between said assigned face name and said target photo image.

8. The photo image managing system according to claim 7, wherein said computer system further comprises a display screen for displaying said selecting interface, said at least one target face image, said plural resembling face images and said plural face names corresponding to said plural resembling face images.

9. The photo image managing system according to claim 8, wherein said selecting module further provides a displaying control interface, wherein said displaying control interface is displayed on said display screen for determining whether a next target face image will be displayed or a next target photo image will be recognized.

10. The photo image managing system according to claim 7, wherein said specified resembling face image is selected by using a finger or a stylus to touch said specified resembling face image shown on said selecting interface, wherein said computer system is an electronic device with a touch control function.

11. The photo image managing system according to claim 7, wherein said specified resembling face image is selected by moving a cursor to click said specified resembling face image shown on said selecting interface, wherein said computer system is a desktop computer or a notebook computer.
